(19) United States
(12) Patent Application Publication
(10) Pub. No.: US 2017/0247563 A1
(43) Pub. Date: Aug. 31, 2017

(54) PROCESS FOR PRODUCING FLUOROOLEFIN COPOLYMER POWDER FOR POWDER COATING MATERIAL, COMPOSITION FOR POWDER COATING MATERIAL, POWDER COATING MATERIAL AND COATED ARTICLE

(71) Applicant: Asahi Glass Company, Limited, Chiyoda-ku (JP)

(72) Inventors: Shun SAITO, Chiyoda-ku (JP); Masataka AIKAWA, Chiyoda-ku (JP); Yuji HARA, Chiyoda-ku (JP)

(73) Assignee: Asahi Glass Company, Limited, Chiyoda-ku (JP)

(21) Appl. No.: 15/592,614

(22) Filed: May 11, 2017

Related U.S. Application Data
(63) Continuation of application No. PCT/JP2015/081385, filed on Nov. 6, 2015.

(30) Foreign Application Priority Data
Nov. 17, 2014 (JP) 2014-232826

(51) Int. Cl. C09D 127/12; B05D 7/14; B05D 7/24; C09D 167/00; B05D 3/00; C09D 5/03; C08J 3/12; B05D 1/06; B05D 3/02

(52) U.S. Cl. CPC C09D 127/12; B05D 1/06; B05D 7/14; B05D 7/24; B05D 3/0254; B05D 3/007; C09D 5/035; C08J 3/12; C09D 167/00; C08J 2327/12

(57) ABSTRACT

To provide a process for producing a fluoroolefin copolymer powder for powder coating material, which presents excellent stability of a fluoroolefin copolymer solution obtainable by polymerization in its production process, and which is capable of forming a cured film having an excellent appearance when used for a powder coating material. A monomer mixture comprising specific monomers is polymerized in an organic solvent in the presence of specific amounts of hydrotalcite and at least one compound (B) selected from a potassium salt, a sodium salt, a magnesium salt and a hindered amine-type light stabilizer, to obtain a suspension; an insoluble component is removed from the suspension to obtain a fluoroolefin copolymer solution having a pH of from 3.8 to 6.5 and an APHA value within a range of from 1 to 200; and the organic solvent is removed from the solution to obtain the fluoroolefin copolymer powder.

### TECHNICAL FIELD

The present invention relates to a process for producing a fluoroolefin copolymer powder for powder coating material, a composition for powder coating material, a powder coating material and a coated article.

### BACKGROUND ART

In recent years, global scale environmental destruction such as global warming, ozone layer depletion, acid rain, etc. has become an international problem. There is an urgent need for global environment pollution measures, and at present, from the viewpoint of environmental protection, various emission regulations are enforced in each country. Among them, discharge of volatile organic compounds (VOC) such as organic solvents into the atmosphere is a serious problem, and under reinforcement of VOC emission regulations, de-VOC is being advanced.

Heretofore, an organic solvent has been used for a coating material, but as de-VOC is being promoted, recently a powder coating material has become to be widely used. The powder coating material contains no organic solvent, and therefore, at the time of coating, it requires no exhaust treatment or no waste water treatment and further can be recovered and reused, and thus, it presents an extremely low environmental load.

Heretofore, as raw materials for powder coating materials, acrylic resins, polyester resins or epoxy resins have been mainly used. However, coating films formed from powder coating materials using these resins as the raw materials, are inferior in weather resistance.

Therefore, as a resin having excellent weather resistance, a fluororesin has attracted attention.

Further, in recent years, the application range of the powder coating material containing a fluoroolefin copolymer, has expanded to aluminum materials used in construction members such as sashes, curtain walls, etc. Along with this, higher flexibility, impact resistance and appearance are now required for the cured film.

As a powder coating material composition to provide a coating film excellent in storage stability with smooth surface and having impact resistance improved, a thermosetting powder coating material composition using a powder of a fluoroolefin copolymer of the following (1) has been proposed (Patent Document 1).

(1) A fluorinated copolymer which comprises fluoro-olefin units, alkene units and cyclohexyl vinyl ether units and/or p-tertiary butyl benzoic acid vinyl units as essential structural units, wherein the total amount of cyclohexyl vinyl ether units and p-tertiary butyl benzoic acid vinyl units occupies from 5 to 45 mol %, and which has a thermal transition temperature of from 45 to 120° C. and which further has crosslinkable reactive groups.

As a powder coating material composition to achieve good coating film appearance and flexibility at the same time, while preventing blocking, a powder coating material composition using a powder of a fluoroolefin copolymer of the following (2) has been proposed (Patent Document 2).

(2) A fluorinated copolymer which is a copolymer obtained by polymerizing a monomer mixture comprising (A) from 45 to 55 mol % of chlorotrifluoroethylene and/or tetrafluoroethylene, (B) from 2 to 40 mol % of a vinyl ether having an alkyl group which is a C₄ or C₅ alkyl group and which contains a tertiary carbon atom, (C) from 5 to 20 mol % of a vinyl ether having a crosslinkable functional group, and (E) from 0 to 32 mol % of a vinyl ester having an alkyl group which is a C₃₋₅ alkyl group and which contains a tertiary or higher carbon atom, wherein the total content of the above (B) and (E) is from 30 to 50 mol %, and which has a glass transition point of at least 50° C. and a number-average molecular weight of from 10,000 to 22,000.

The powder of the fluoroolefin copolymer of the above (1) or (2), is produced by polymerizing a monomer mixture in the presence of an organic solvent, followed by removing the organic solvent from the obtained fluoroolefin copolymer solution. However, in the fluoroolefin copolymer of the above (1) or (2), the fluoroolefin copolymer solution after polymerization is likely to vigorously undergo yellowing. Consequently, a cured film to be formed by using a powder obtained from such a fluoroolefin copolymer solution, is likely to have an appearance abnormality such as yellowing. Especially in the case of an application to a clear powder coating material containing no pigment, or an application to a light-colored powder coating material containing titanium oxide, yellowing tends to distinctly appear.

Further, in the production of a fluoroolefin copolymer, by an inorganic acid component (such as hydrofluoric acid) generated in the course of polymerizing the monomer mixture, stability of the solution is likely to be impaired during polymerization or after polymerization of the monomers, whereby the solution tends to be gelled, or the molecular weight of the copolymer tends to be increased. As a method for producing a highly stable solution, a method of polymerizing a monomer mixture consisting of a fluoroolefin, a vinyl ether having a hydroxy group, and, as the case requires, other monomers, in the presence of a compound having a 2,2,6,6-tetra-substituted piperidyl group (Patent Document 3), or a method of treating a fluoroolefin copolymer solution with a basic solid substance such as hydrotalcite (Patent Document 4), is known.

However, a fluoroolefin copolymer-containing solution obtained by such a method, is likely to undergo discoloration (yellowing, cloudiness), or the molecular weight of the copolymer is likely to be increased, during storage. Further, in a case where a curing agent is blended to the fluoroolefin copolymer-containing solution obtained by such a method, to obtain a coating material composition, the coating material composition is likely to undergo yellowing during storage, the gloss of a coating film to be formed from the coating material composition after storage for a prolonged period of time tends to be insufficient, such a coating film is likely to be discolored, and even a coating film formed from the coating material composition immediately after formulation, is insufficient in resistance to boiling water, alkali resistance and moisture resistance.

### PRIOR ART DOCUMENTS

### Patent Documents

Patent Document 1: WO2002/100956

Patent Document 2: WO2007/132736

Patent Document 3: JP-A-62-292814

Patent Document 4: JP-A-01-197510

### DISCLOSURE OF INVENTION

### Technical Problem

The present invention is to provide a process for producing a fluoroolefin copolymer powder for powder coating material, which presents excellent stability of a fluoroolefin copolymer solution obtainable by polymerization in its production process, and which is capable of forming a cured film excellent in appearance when used for a powder coating material.

Further, the present invention is to provide a composition for powder coating material, and a powder coating material, capable of forming a cured film excellent in appearance.

Further, the present invention is to provide a coated article having a cured film excellent in appearance.

### Solution To Problem

The present invention provides a process for producing a fluoroolefin copolymer powder for powder coating material, a composition for powder coating material, a powder coating material, a coated article and an aluminum exterior material for sashes and curtain walls, having the following constructions [1] to [13].

[1] A process for producing a fluoroolefin copolymer powder for powder coating material, characterized by comprising:

a step (I) of polymerizing a monomer mixture comprising the following monomer (a1), the following monomer (a2) and the following monomer (a3) in an organic solvent in the presence of the following compound (B) and hydrotalcite, to obtain a suspension, a step (II) of removing an insoluble component from the suspension, to obtain a fluoroolefin copolymer solution, and

a step (III) of removing the organic solvent from the fluoroolefin copolymer solution to obtain a fluoroolefin copolymer powder in which a non-volatile content is within a range of from 99 to 100 mass %,

wherein in the step (I), the amount of the compound (B) is from 0.05 to 10 parts by mass to 100 parts by mass of the monomer mixture, and the amount of hydrotalcite is from 0.05 to 10 parts by mass to 100 parts by mass of the monomer mixture,

and of the fluoroolefin copolymer solution, the pH is from 3.8 to 6.5, and the APHA value is within a range of from 1 to 200,

Monomer (a1): a fluoroolefin,

Monomer (a2): a monomer having a crosslinkable group,

Monomer (a3): a vinyl ester having no crosslinkable group,

Compound (B): at least one compound selected from a potassium salt, a sodium salt, a magnesium salt and a hindered amine-type light stabilizer.

[2] The process for producing a fluoroolefin copolymer powder for powder coating material according to [1], wherein the monomer (a2) is a vinyl ether having a crosslinkable group.
[3] The process for producing a fluoroolefin copolymer powder for powder coating material according to [1] or [2], wherein the crosslinkable group in the monomer (a2) is a hydroxy group.
[4] The process for producing a fluoroolefin copolymer powder for powder coating material according to any one of [1] to [3], wherein the proportion of the monomer (a1) in the monomer mixture is from 20 to 80 mol % to the total of all monomers constituting the monomer mixture.
[5] The process for producing a fluoroolefin copolymer powder for powder coating material according to any one of [1] to [4], wherein the proportion of the monomer (a2) in the monomer mixture is from 0.5 to 30 mol % to the total of all monomers constituting the monomer mixture.
[6] The process for producing a fluoroolefin copolymer powder for powder coating material according to any one of [1] to [5], wherein the proportion of the monomer (a3) in the monomer mixture is from 0.5 to 30 mol % to the total of all monomers constituting the monomer mixture.
[7] The process for producing a fluoroolefin copolymer powder for powder coating material according to any one of [1] to [6], wherein the monomer mixture further contains at least one member selected from the group consisting of the following monomer (a4-1) and the following monomer (a4-2),

Monomer (a4-1): cyclohexyl vinyl ether,

Monomer (a4-2): a vinyl ether having a branched alkyl group and no crosslinkable group.

[8] A composition for powder coating material comprising a fluoroolefin copolymer powder obtained by the process for producing a fluoroolefin copolymer powder as defined in any one of [1] to [7] and a blocked isocyanate-type curing agent.
[9] The composition for powder coating material according to [8], which further contains a non-fluororesin in an amount of from 10 to 400 parts by mass to 100 parts by mass of the fluoroolefin copolymer powder.
[10] The composition for powder coating material according to [9], wherein the non-fluororesin is a polyester resin.
[11] A powder coating material comprising the composition for powder coating material as defined in any one of [8] to [10].
[12] A coated article having a coating film formed from the powder coating material as defined in [11], on the surface of a substrate.
[13] The coated article according to [12], wherein the substrate is made of aluminum.

### Advantageous Effects of Invention

In the process for producing a fluoroolefin copolymer powder for powder coating material of the present invention, the stability of the fluoroolefin copolymer solution obtained by polymerization in the process for producing the fluoroolefin copolymer powder will be excellent. Further, the obtainable fluoroolefin copolymer powder can form, when used for a powder coating material, a cured film excellent in appearance.

Each of the composition for powder coating material, and the powder coating material, of the present invention, can form a cured film excellent in appearance.

The coated article of the present invention has a cured film excellent in appearance.

### DESCRIPTION OF EMBODIMENT

The following definitions of terms apply throughout the present specification including claims.

A “fluoroolefin” means a compound having some or all of hydrogen atoms bonded to carbon atoms in an olefinic hydrocarbon substituted by fluorine atoms. It may have substituted atoms or substituted groups other than fluorine atoms. However, one having a crosslinkable group is excluded.

A “crosslinkable group” means a functional group which causes substantially no reaction at the time of producing a fluoroolefin copolymer and which causes cross-linking between molecules of a fluoroolefin copolymer by reacting with e.g. a curing agent.

The term “hydrotalcite” means a layered double hydroxide represented by the following formula.

[Mg²⁺₁₋ₓAl³⁺x(OH)₂]^{x+}[CO₃²⁻_{x/2}.mH₂O]x⁻, where x is from 0.2 to 0.33, and m is from 0 to 2.

The term “(meth)acrylic acid” means acrylic acid or methacrylic acid.

A “(meth)acrylate” is a generic term for an acrylate and a methacrylate.

A “non-fluororesin” means a polymer compound having no fluorine atom in its molecule, and a low molecular weight compound which becomes, as cured by e.g. crosslinking, a polymer compound having no fluorine atom in its molecule.

A “glass transition temperature” means a midpoint glass transition temperature measured by a differential scanning calorimetry (DSC) method.

A “coating film” means a film formed by applying, melting and cooling a powder coating material.

A “cured film” means a film formed by curing the above coating film.

A “unit” means a moiety which is present in a polymer to constitute the polymer and which is based on a monomer. Further, one having a structure of a certain unit chemically modified after forming a polymer, will also be referred to as a unit. Further, units based on a specific monomer may be represented by a name having “units” attached to the monomer name.

### [Process for Producing Fluoroolefin Copolymer Powder for Powder Coating Material]

The fluoroolefin copolymer in the present invention is a copolymer obtainable by copolymerizing the following monomer mixture by the process of the present invention. Hereinafter, this fluoroolefin copolymer will be referred to also as “copolymer (A)”.

### <Monomer Mixture>

The monomer mixture to be polymerized in step (I) comprises the following monomer (a1), the following monomer (a2) and the following monomer (a3).

The monomer mixture preferably further contains at least one member selected from the group consisting of the following monomer (a4-1) and the following monomer (a4-2).

The monomer mixture may further contain, as the case requires, monomers (hereinafter referred to as other monomers) other than the monomer (a1), (a2), (a3), (a4-1) and (a4-2) within a range not to impair the effects of the present invention.

A “monomer” in the monomer mixture means a compound having a polymerization reactive carbon-carbon double bond.

(Monomer (a1))

The monomer (a1) is a fluoroolefin.

The number of fluorine atoms in the fluoroolefin is preferably at least 2, more preferably from 2 to 6, further preferably 3 or 4. When the number of fluorine atoms is at least 2, the obtainable cured film will be excellent in weather resistance.

The monomer (a1) may, for example, be tetrafluoroethylene, chlorotrifluoroethylene, vinylidene fluoride, hexafluoropropylene, etc., and tetrafluoroethylene or chlorotrifluoroethylene is preferred.

As the monomer (a1), one type may be used alone, or two or more types may be used in combination.

(Monomer (a2))

The monomer (a2) is a monomer having a crosslinkable group.

As the crosslinkable group, a functional group having active hydrogen (such as a hydroxy group, a carboxy group or an amino group), a hydrolyzable silyl group (such as an alkoxysilyl group) or the like is preferred.

As the monomer (a2), a monomer represented by the following formula (2-1) is preferred.

CH_{2═}CX¹(CH₂)ₙ₁-Q¹-R¹—Y (2-1)

wherein X¹ is a hydrogen atom or a methyl group, n1 is 0 or 1, Q¹ is an oxygen atom, —C(O)O— or O(O)C—, R¹ is a C₂₋₂₀ alkylene group which may have a branched structure or a ring structure, and Y is a cross-linkable functional group.

As Y, a hydroxy group, a carboxy group or an amino group is preferred, and a hydroxy group is more preferred.

As R¹, a linear alkylene group is preferred. The number of carbon atoms in the alkylene group is preferably from 1 to 10, more preferably from 1 to 6, further preferably from 2 to 4.

As Q¹, an oxygen atom is preferred.

The monomer (a2) may, for example, be a hydroxyalkyl vinyl ether, a hydroxyalkyl vinyl carboxylate, a hydroxyalkyl allyl ether, a hydroxyalkyl allyl carboxylate, a hydroxyalkyl (meth)acrylate, etc.

As the monomer (a2), preferred is a hydroxyalkyl vinyl ether (2-hydroxyethyl vinyl ether, hydroxymethyl vinyl ether, 4-hydroxybutyl vinyl ether (HBVE), etc.), a hydroxyalkyl allyl ether (hydroxyethyl allyl ether, etc.), a hydroxyalkyl (meth)acrylate (2-hydroxyethyl (meth)acrylate, etc.), and from the viewpoint of excellent copolymerizability, and excellent weather resistance of a cured film to be formed, more preferred is a hydroxyalkyl vinyl ether, and particularly preferred is HBVE.

As the monomer (a2), one type may be used alone, or two or more types may be used in combination.

(Monomer (a3))

The monomer (a3) is a vinyl ester having no crosslinkable group.

The monomer (a3) may, for example, be a vinyl alkyl carboxylate, a vinyl aromatic carboxylate, etc.

The alkyl group in the vinyl alkyl carboxylate may be linear or branched, and the number of carbon atoms is preferably from 3 to 20. As such an alkyl group, with a view to increasing Tg (glass transition temperature) of the copolymer (A) and lowering the viscosity when melted, preferred is a branched alkyl group, and more preferred is an alkyl group containing a tertiary carbon atom. The number of carbon atoms of the branched alkyl group is preferably from 3 to 10, more preferably 4 or 5.

As the monomer (a3), preferred is vinyl pivalate (referred to also as pivalic acid vinyl), vinyl isobutyrate, vinyl isovalerate, vinyl hydro angelate, vinyl acetate, vinyl benzoate, etc., and particularly preferred is vinyl pivalate.

As the monomer (a3), one type may be used alone, or two or more types may be used in combination.

(Monomer (a4-1))

The monomer (a4-1) is cyclohexyl vinyl ether.

(Monomer (a4-2))

The monomer (a4-2) is a vinyl ether having a branched alkyl group and no crosslinkable group.

As the branched alkyl group, preferred is an alkyl group containing a tertiary carbon atom.

The number of carbon atoms in the branched alkyl group is preferably from 3 to 10, more preferably 4 or 5.

As the monomer (a4-2), an alkyl vinyl ether having a branched alkyl group is preferred, and, for example, tert-butyl vinyl ether, isobutyl vinyl ether, neopentyl vinyl ether, 2-ethylpropyl vinyl ether or the like may be mentioned. Among them, with a view to increasing Tg (glass transition temperature) of the copolymer (A) and lowering the viscosity when melted, tert-butyl vinyl ether is particularly preferred.

As the monomer (a4-2), one type may be used alone, or two or more types may be used in combination.

### (Other Monomers)

Other monomers are not particularly limited so long as they are copolymerizable with the monomers (a1), (a2), (a3), (a4-1) and (a4-2). They may, for example, be allyl ethers having no crosslinkable group, allyl esters having no crosslinkable group, (meth)acrylic acid esters having no crosslinkable group, alkyl vinyl ethers having a linear alkyl group, styrene derivatives, ethylene derivatives, propylene derivatives, etc.

As other monomers, one type may be used alone, or two or more types may be used in combination.

### (Composition of Monomer Mixture)

The proportion of the monomer (a1) in the monomer mixture is preferably from 20 to 80 mol %, more preferably from 30 to 70 mol %, further preferably from 40 to 60 mol %, in the total (100 mol %) of all monomers constituting the monomer mixture. When the proportion of the monomer (a1) is at least the lower limit value in the above range, a cured film to be formed from a powder coating material containing the obtainable copolymer (A) powder will be excellent in weather resistance. When the proportion of the monomer (a1) is at most the upper limit value in the above range, it is possible to adjust Tg (glass transition temperature) of the copolymer (A) to Tg suitable for a powder coating material, whereby the copolymer (A) powder after pulverization will be less likely to be agglomerated.

The proportion of the monomer (a2) in the monomer mixture is preferably from 0.5 to 30 mol %, more preferably from 1 to 25 mol %, further preferably from 2 to 20 mol %, in the total (100 mol %) of all monomers constituting the monomer mixture. When the proportion of the monomer (a2) is at least the lower limit value in the above range, a sufficient amount of crosslinkable groups in order to obtain a highly hard cured film will be introduced into the copolymer (A). When the proportion of the monomer (a2) is at most the upper limit value in the above range, gelation is less likely to occur during the polymerization.

The proportion of the monomer (a3) in the monomer mixture is preferably from 0.5 to 30 mol %, more preferably from 1 to 25 mol %, further preferably from 2 to 20 mol %, in the total (100 mol %) of all monomers constituting the monomer mixture. When the proportion of the monomer (a3) is at least the lower limit value in the above range, a cured film to be formed from a powder coating material containing the obtainable copolymer (A) powder will be excellent in smoothness and impact resistance. When the proportion of the monomer (a3) is at most the upper limit value in the above range, a cured film to be formed from a powder coating material containing the obtainable copolymer (A) powder will be excellent in weather resistance.

The proportion of the monomer (a4-1) in the monomer mixture is preferably from 0.5 to 30 mol %, more preferably from 1 to 25 mol %, further preferably from 2 to 20 mol %, in the total (100 mol %) of all monomers constituting the monomer mixture. When the proportion of the monomer (a4-1) is at least the lower limit value in the above range, it is possible to adjust Tg (glass transition temperature) of the copolymer (A) to Tg of a resin suitable for a powder coating material, and the copolymer (A) powder after pulverization will be less likely to be agglomerated. When the proportion of the monomer (a4-1) is at most the upper limit value in the above range, a cured film to be formed from a powder coating material containing the obtainable copolymer (A) powder will be excellent in weather resistance.

The proportion of the monomer (a4-2) in the monomer mixture is preferably from 0.5 to 30 mol %, more preferably from 1 to 25 mol %, further preferably from 2 to 20 mol %, in the total (100 mol %) of all monomers constituting the monomer mixture. When the proportion of the monomer (a4-2) is at least the lower limit value in the above range, it is possible to adjust Tg (glass transition temperature) of the copolymer (A) to Tg of a resin suitable for a powder coating material, and the copolymer (A) powder after pulverization will be less likely to be agglomerated. When the proportion of the monomer (a4-2) is at most the upper limit value in the above range, a cured film to be formed from a powder coating material containing the obtainable copolymer (A) powder will be excellent in smoothness and impact resistance.

The proportion of other monomers in the monomer mixture is preferably at most 10 mol %, more preferably at most 5 mol %, in the total (100 mol %) of all monomers constituting the monomer mixture.

### <Fluoroolefin Copolymer>

A fluoroolefin copolymer (copolymer (A)) obtainable by the production process of the present invention comprises units derived from monomer (a1), units derived from monomer (a2) and units based on monomer (a3). Further, it preferably further contains units based on at least one member selected from the group consisting of monomer (a4-1) and monomer (a4-2). It may further contain units based on other monomers.

A preferred proportion of the units based on the monomer (a1) to the total (100 mol %) of all units constituting the copolymer (A) is the same as the above-mentioned preferred proportion of the monomer (a1) in the monomer mixture. The same applies to other units.

The number-average molecular weight of the copolymer (A) is preferably from 3,000 to 200,000, more preferably from 5,000 to 100,000. When the number-average molecular weight of the copolymer (A) is at least the lower limit value in the above range, an obtainable cured film will be excellent in strength, weather resistance, etc. When the number-average molecular weight of the copolymer (A) is at most the upper limit value in the above range, increase in the melt viscosity in a region of from 160 to 220° C. being a common baking temperature for a thermosetting powder coating material will be suppressed, so that an obtainable cured film will be excellent in appearance.

The number-average molecular weight of the copolymer (A) is measured by gel permeation chromatography (GPC) using polystyrene as a standard substance.

The glass transition temperature of the copolymer (A) is preferably from 30 to 100° C., more preferably from 40 to 80° C. When the glass transition temperature of the copolymer (A) is at least the above lower limit value, the operation efficiency for the production of a powder coating material will be excellent. For example, the copolymer (A) is less likely to be agglomerated (less likely to undergo blocking) after pulverization, thereby to facilitate the production of a powder coating material. When the glass transition temperature of the copolymer (A) is at most the above upper limit value, the surface smoothness of an obtainable cured film will be excellent.

### <Compound (B)>

The compound (B) is at least one compound selected from a potassium salt, a sodium salt, a magnesium salt and a hindered amine-type light stabilizer.

As the counter ion (anion) for forming a salt with a potassium ion in the potassium salt, preferred is one, of which the pH of the aqueous solution at 25° C. at the time when 5 g of the potassium salt is dissolved in 100 mL of deionized water, is within a range of from 7.5 to 13.0, and, for example, a carbonate ion, an acetate ion, a citrate ion, a formate ion, a gluconate ion, a lactate ions, an oxalate ion, a tartarate ion, a phosphorate ion, a borate ion, etc. may be mentioned. Among them, from the viewpoint of availability, solubility in water, low odor, low contamination and low associative nature, a carbonate ion is particularly preferred. That is, as the potassium salt, potassium carbonate is particularly preferred.

In each of the sodium salt and the magnesium salt, as the counter ion (anion) for forming a salt with a sodium ion or magnesium ion, the same one as the counter ion in the potassium salt may be mentioned, and the preferred embodiment is also the same. As the hindered amine-type light stabilizer, from such a viewpoint that in the step (III), it is less likely to be volatilized at the time of removing the solvent from the copolymer (A) solution, and will remain in the copolymer (A) powder, so as to suppress formation of an acid component for a long period of time, preferred is a hindered amine-type light stabilizer having a molecular weight of from 200 to 5,000 and a melting point of from 50 to 250° C., and more preferred is a hindered amine-type light stabilizer having a molecular weight of from 300 to 4,000 and a melting point of from 55 to 200° C.

Commercially available products of hindered amine-type light stabilizer may, for example be, as manufactured by BASF, “Tinuvin (registered trademark) 111FDL” (molecular weight: 2,000 to 4,000, a melting point: 115 to 150° C.), “Tinuvin (registered trademark) 144” (molecular weight: 685, melting point: 146 to 150° C.), “Tinuvin (registered trademark) 152” (molecular weight: 756.6, melting point: 83 to 90° C.), as manufactured by Clariant, “Sanduvor (registered trademark) 3051 powder” (molecular weight: 364.0, melting point: 225° C.), “Sanduvor (registered trademark) 3070 powder” (molecular weight: 1,500, melting point: 148° C.), “VP Sanduvor (registered trademark) PR-31” (molecular weight: 529, melting point: 120 to 125° C.), etc.

As the compound (B), one type may be used alone, or two or more types may be used in combination.

The compound (B) preferably contains at least a hindered amine-type light stabilizer with a view to suppressing coloration of the copolymer (A) solution. In such a case, the compound (B) may be composed solely of the hindered amine-type light stabilizer, or may be a mixture of a hindered amine-type light stabilizer with at least one member selected from a potassium salt, a sodium salt and a magnesium salt.

### <Hydrotalcite>

The hydrotalcite is preferably one which can sufficiently absorb an acid component (such as hydrogen chloride).

As the hydrotalcite, from the viewpoint of capability of sufficiently absorbing an acid component and easy availability, preferred is Mg₆Al₂(OH)₁₆CO₃.4H₂O (x=0.25, m=0.5), or Mg_{4.5}Al₂(OH)₁₃CO₃.3.5H₂O (x=0.308, m=0.538).

As the hydrotalcite, one type may be used alone, or two or more types may be used in combination.

The particle size of the hydrotalcite is preferably from 5 to 500 μm, more preferably from 5 to 110 μm. When the particle size of the hydrotalcite is at least 5 μm, removal by filtration will be facilitated. When the particle size of the hydrotalcite is at most 500 μm, a surface area per unit mass will be large, whereby the effect of hydrotalcite will be sufficiently exhibited.

The particle size of the hydrotalcite is measured in accordance with “Sieving test method of chemical products” of JIS K0069.

### <Organic Solvent>

As the organic solvent, one which dissolves the monomer mixture and the copolymer (A) is used.

As the organic solvent, preferred is at least one organic solvent (hereinafter referred to as an organic solvent (D1)) selected from the group consisting of an aromatic hydrocarbon solvent, a ketone solvent, an ester solvent, and a Type III organic solvent in the Industrial Safety and Health Law. In a conventional method, in a case where the organic solvent is an organic solvent (D1), discoloration of the copolymer (A) solution is likely to occur, and therefore, usefulness of the present invention is high in the case where the organic solvent is an organic solvent (D1).

As the aromatic hydrocarbon solvent, preferred is toluene, xylene, ethylbenzene, aromatic petroleum naphtha, tetralin, turpentine oil, Solvesso (registered trademark) #100 (manufactured by Exxon Mobil Corporation), or Solvesso (registered trademark) #150 (manufactured by Exxon Mobil Corporation).

As the ketone solvent, preferred is acetone, methyl ethyl ketone, methyl amyl ketone, methyl isobutyl ketone, ethyl isobutyl ketone, diisobutyl ketone, cyclohexanone, or isophorone.

As the ester solvent, preferred is methyl acetate, ethyl acetate, n-propyl acetate, isobutyl acetate, or tert-butyl acetate.

The Type Ill organic solvent in the Industrial Safety and Health Law is at least one solvent selected from the group consisting of gasoline, coal tar naphtha (including solvent naphtha), petroleum ether, petroleum naphtha, petroleum benzine, turpentine, and mineral spirits (including mineral thinner, petroleum spirit, white spirit and mineral terpene).

As the Type III organic solvent in the Industrial Safety and Health Law, from such a viewpoint that the flash point is above room temperature, preferred are mineral spirits (including mineral thinner, petroleum spirit, white spirit and mineral turpentine).

From the viewpoint of reducing environmental impact, preferred as the organic solvent (D1) is a solvent which satisfies PRTR Law and HAPs regulations, i.e. an organic solvent having no aromatic ring. Further, an organic solvent which is classified in the Type III organic solvent in the classification of organic solvents by the Industrial Safety and Health Law, is preferred. Specifically, a ketone solvent or ether ester solvent which does not correspond to PRTR Law or HAPs regulations, or a paraffinic solvent or naphthenic solvent which is classified in the Type Ill organic solvent in the Industrial Safety and Health Law, is preferred.

Here, the “ether ester solvent” is meant for a solvent consisting of a compound having both an ether bond and an ester bond in its molecule.

The organic solvent may contain an organic solvent other than the organic solvent (D1). As another organic solvent, an alcohol solvent or ether ester solvent is preferred.

As the alcohol solvent, preferred is one having at most 4 carbon atoms, and specifically, ethanol, tert-butyl alcohol, or iso-propyl alcohol, is preferred.

As the ether ester solvent, preferred is ethyl 3-ethoxypropionate, propylene glycol monomethyl ether acetate, or methoxybutyl acetate.

As another organic solvent, ethanol or tert-butyl alcohol is, for example, more preferred.

As the organic solvent, one type may be used alone, or two or more types may be used in combination.

The proportion of the organic solvent (D1) in the organic solvent is preferably from 10 to 100 mass %, more preferably from 30 to 95 mass %, in the organic solvent (100 mass %). When the proportion of the organic solvent (D1) is at least 10 mass %, solubility in the organic solvent of the copolymer (A) will be good.

### <Step (I)>

In the step (I), the above monomer mixture is polymerized in an organic solvent in the presence of the compound (B) and hydrotalcite, as well as a polymerization initiator as the case requires, to obtain a suspension.

This suspension is in such a state that an insoluble component among the compound (B) and the hydrotalcite is suspended in a solution having the copolymer (A) formed by polymerization dissolved in an organic solvent.

The monomer mixture is polymerized by a so-called solution polymerization method.

As the solution polymerization method, the following methods may specifically be mentioned.

(i) A method in which the monomer mixture, the compound (B), hydrotalcite, an organic solvent and, as the case requires, a polymerization initiator, are charged all at once into a reactor, and polymerized. Charging sequence may suitably be set.

(ii) A method in which to a reactor charged with the monomer (a1), the compound (B), hydrotalcite and an organic solvent, monomers (monomer (a2), monomer (a3), etc.) other than the monomer (a1) and, as the case requires, a polymerization initiator are continuously or dividedly added. The monomers other than the monomer (a1) and the polymerization initiator may be added together with the organic solvent as mixed, or charging sequence may suitably be set.

(iii) A method in which to a reactor charged with the compound (B), hydrotalcite and an organic solvent, the monomer mixture and a polymerization initiator are continuously or dividedly added. The monomer mixture and the polymerization initiator may be added together with the organic solvent as mixed, or charging sequence may be suitably set.

(iv) A method in which to a reactor charged with the compound (B), hydrotalcite and an organic solvent and further charged with a part of the monomer mixture (for example, a part or all of one or two members among the monomer (a1), the monomer (a2) and the monomer (a3)), the rest of the monomer mixture and, as the case requires, a polymerization initiator, are continuously or dividedly added. The rest of the monomers and the polymerization initiator may be added together with the organic solvent as mixed, or charging sequence may be suitably set.

The polymerization initiator may, for example, be an azo initiator, a peroxide initiator, a diacyl peroxide, a dialkyl peroxide, a peroxy ketal, an alkyl perester, a percarbonate, etc.

The amount of the compound (B) to be used in the step (I) is from 0.05 to 10 parts by mass, preferably from 0.07 to 9 parts by mass, more preferably from 0.1 to 8 parts by mass, to 100 parts by mass of the monomer mixture.

Further, the amount of hydrotalcite is from 0.05 to 10 parts by mass, preferably from 0.07 to 9 parts by mass, more preferably from 0.1 to 8 parts by mass, to 100 parts by mass of the monomer mixture.

When the amount of the compound (B) and the amount of hydrotalcite are within the above ranges, respectively, the stability of the suspension obtainable in the step (I) and the copolymer (A) solution obtainable in the step (II) will be improved. For example, an increase in the molecular weight of the copolymer (A) in the suspension or copolymer (A) solution, or discoloration of the suspension or copolymer (A) solution, will be less likely to occur. Further, at the time of forming a cured film by using the composition for powder coating material obtainable by blending a blocked isocyanate-type curing agent to the finally obtainable copolymer (A) powder, there will be no difference in curing rate between a coating film surface and inside of the coating film, and gloss reduction of the film attributable to wrinkles at the surface layer of the cured film tends to be less likely to occur.

If the amount of the compound (B) is less than the lower limit value in the above range, the fluoroolefin polymer is likely to be gelled during the polymerization. If the amount of the compound (B) exceeds the upper limit value in the above range, in the suspension after polymerization, a profound haze is likely to occur which cannot be removed even in the step (II), whereby the gloss of the coating film may be lost.

If the amount of hydrotalcite is less than the lower limit value in the above range, the fluoroolefin polymer is likely to be gelled during the polymerization. If the amount of hydrotalcite exceeds the upper limit value in the above range, the filter tends to be clogged during the filtration in the step (II).

The amount of the organic solvent is preferably such an amount that the solid content concentration in the suspension obtainable in the step (I) will be within a range of from 20 to 80 mass %. The solid content concentration in the suspension will be more preferably from 30 to 70 mass %, particularly preferably from 40 to 60 mass %. When the solid content concentration of the suspension is at least the lower limit value in the above range, it will be easy to carry out solid-liquid separation such as filtration in the step (II). When the solid content concentration of the suspension is at most the upper limit value in the above range, a load required for removal of the solvent in the step (III) will be small.

### <Step (II)>

In the step (II), an insoluble component is removed from the suspension to obtain a copolymer (A) solution. Specifically, the suspension obtained in the step (I) is subjected to solid-liquid separation such as filtration, to remove hydrotalcite which is present as an insoluble component in the suspension. By removing the hydrotalcite, when a finally obtainable copolymer (A) powder is used for a powder coating material, a cured film having good appearance (gloss, transparency) can be formed.

The pH of the copolymer (A) solution is within a range of from 3.8 to 6.5, preferably from 3.9 to 6.3, particularly preferably from 4.0 to 6.0. When the pH is at least the lower limit value in the above range, at the time of forming a cured film by using a composition for powder coating material obtainable by adding a blocked isocyanate-type curing agent to the copolymer (A) powder, there will be no difference in the curing rate between the surface layer and inside of the coating film, whereby a gloss reduction of a cured film attributable to wrinkles at the surface layer of the cured film tends to be less likely to occur. When the pH is at most the upper limit value in the above range, curing failure is less likely to occur in the coating film, and a cured film will be excellent in durability such as acid resistance, alkali resistance, solvent resistance, etc.

The pH of the copolymer (A) solution is measured by the measuring method shown later in Examples.

The pH of the copolymer (A) solution may be adjusted by the type and amount of the compound (B), the amount of hydrotalcite used in the step (I), etc. For example, as the amount of the compound (B) or hydrotalcite increases within the above range, the pH of the copolymer (A) solution tends to be higher.

The APHA value of the copolymer (A) solution is within a range of from 1 to 200, preferably from 2 to 190, particularly preferably from 3 to 180. When the APHA value is at most the upper limit value in the above range, there will be little coloration of the powder coating material, and less influence on a light colored coating film, whereby a clear coating color appearance can be easily obtained.

The APHA value is an index representing the color of a liquid and is measured in accordance with ASTM D1209.

The APHA value of the copolymer (A) solution may be adjusted by the type and amount of the compound (B), the amount of hydrotalcite used in the step (I), etc. For example, as the amount of the compound (B) increases within the above range, the APHA value of the copolymer (A) solution tends to increase. As the amount of hydrotalcite increases within the above range, the APHA value of the copolymer (A) solution tends to decrease.

### <Step (III)>

In the step (III), the organic solvent is removed from the copolymer (A) solution, to obtain a copolymer (A) powder in which a nonvolatile content is within a range of from 99 to 100 mass %.

As the method of removing the organic solvent, a known method may be used, and although not particularly limited, a method of using a thin-film vacuum evaporator is preferred. By supplying the copolymer (A) solution to a thin film vacuum evaporator and removing the organic solvent by the thin film vacuum evaporator, it is possible to remove the organic solvent in a short time, and it is possible to reduce the thermal load exerted to the fluoroolefin polymer, to suppress formation of an acid component and to prevent gelation.

As the thin film vacuum evaporator, a known one may be used, and, for example, a centrifugal thin film vacuum evaporator, a belt-type thin film vacuum evaporator, or a screw-type thin film vacuum evaporator may be mentioned.

The conditions for removal of the organic solvent by a thin film vacuum evaporator are not particularly limited, and the removal can be conducted by reduced pressure, by heating, or by a combination thereof. The combination of heating and reduced pressure is preferred, since the removal efficiency is good, and deterioration due to heat of the copolymer (A) can be suppressed, as compared to the case of using only heating. The vacuum degree (pressure-reducing degree) at the time of removing the organic solvent is preferably from 1.0 to 3,000 Pa, more preferably from 2.0 to 2,500 Pa, further preferably from 3.0 to 2,000 Pa.

The temperature at the time of removing the organic solvent is preferably from 20 to 200° C., more preferably from 30 to 190° C., further preferably from 40 to 180° C.

After removal of the organic solvent, the obtained powder may be directly used as a copolymer (A) powder for powder coating material, or may be, as the case requires, subjected to treatment such as cooling, pulverization by a pulverizer, classification by a mesh filtration, etc. From the viewpoint of the operation efficiency at the time of producing a powder coating material, it is preferred to conduct pulverization by a pulverizer.

Cooling is carried out typically when the temperature of the powder after removal of the solvent is high (e.g. 40 to 180° C.), so that the temperature becomes to be from 0 to 30° C.

As the pulverizer, it is possible to use a known pulverizer. The type of the pulverizer may, for example, be a pin mill, a hammer mill, a jet mill, etc.

In order to remove particles with too small particle sizes or particles with too large particle sizes, it is preferred to carry out the classification after pulverization. When conducting such classification, it is preferred to remove at least either particles with particle sizes of less than 10 μm or particles with particle sizes exceeding 100 μm.

The classification method may, for example, be a sieving method or an air classification method.

The average particle size of the copolymer (A) powder is preferably from 15 to 50 μm.

The average particle size is obtained as a 50% diameter (median diameter) in the volume-based particle size distribution. Measurement of the particle size distribution is usually carried out by using a particle size distribution measuring apparatus, such as a type to capture the potential change at the time of passing through a pore, a laser diffraction system, an image judging type, a sedimentation rate measuring system, etc.

### <Function and Effects>

In the above-described production process of the present invention, the monomer mixture is polymerized in the presence of the compound (B) and hydrotalcite in the respective predetermined amounts, whereby the suspension and the copolymer (A) solution obtainable in the production process will be excellent in stability. For example, increase in the molecular weight of the copolymer (A) in the suspension or the copolymer (A) solution, or discoloration (yellowing, cloudiness) of the suspension or the copolymer (A) solution, is less likely to occur. Further, a cured film to be formed by using the obtainable copolymer (A) powder will be excellent in appearance (gloss, smoothness, transparency, etc.).

The above effects are considered to be obtainable, since components (e.g. acid components such as hydrogen fluoride, hydrogen chloride, etc., an oligomer component, etc.) formed during or after the polymerization of the monomer mixture, which increase the molecular weight of the copolymer (A) or discolor the suspension or the copolymer (A) solution, are sufficiently removed by the compound (B) and hydrotalcite.

Further, by letting the compound (B) and hydrotalcite be coexisting at the time of polymerization within the above respective ranges, said components will be sufficiently removed, and occurrence of the above mentioned defects will be suppressed. For example, as acid components are sufficiently removed, a pH variation of the solution will be reduced, and the stability of the suspension obtainable in the step (I) or the copolymer (A) solution obtainable in the step (II) will be improved, so that consequently discoloration will be less likely to occur.

Further, since acid components are sufficiently removed, at the time of forming a cured film by using a composition for powder coating material obtainable by adding an blocked isocyanate-type curing agent to the copolymer (A) powder, there will be no difference in the curing rate between the surface layer and inside of the coating film, whereby a gloss reduction of a cured film attributable to wrinkles at the surface layer of the cured film will be less likely to occur. Further, since, after polymerization, insoluble components such as hydrotalcite, etc. are removed prior to removal of the solvent, at the time when the obtainable copolymer (A) powder is used for the powder coating material, there will be no deterioration of the appearance of the cured film by such insoluble components.

The use in combination of the compound (B) and hydrotalcite is particularly effective in removing acid components. Formation mechanisms of acid components during or after polymerization of the monomers are present in a plurality. The above effects become insufficient with only one of the compound (B) and hydrotalcite, and therefore, it is considered that the compound (B) and hydrotalcite would, respectively, trap the formed acid components by different mechanisms.

The compound (B) will, since it has a basicity, react with an acid component to trap the acid. Among the compounds (B), a potassium salt, a sodium salt and a magnesium salt are considered to be effective to trap an acid component of an inorganic acid such as hydrofluoric acid or hydrochloric acid. A hindered amine-type light stabilizer is considered to be effective to trap an organic carboxylic acid component formed by decomposition of a monomer component. A hindered amine-type light stabilizer is effective, not only for trapping an acid component, but also for suppressing generation of the acid component.

Hydrotalcite will trap an acid component by incorporating the acid component in the interlayer, and therefore, it is effective not only for an inorganic acid such as hydrofluoric acid or hydrochloric acid, but also for an organic carboxylic acid component.

Hydrotalcite is excellent in the effect to remove acid components, but it is an insoluble component, and therefore is removed in the step (II) for the quality of the coating film. A part or all of the compound (B) will be dissolved in water and will remain without being removed in the step (II), whereby the stability during storage of the copolymer (A) solution or the copolymer (A) powder will be maintained to be good.

### [Composition for Powder Coating Material]

The composition for powder coating material of the present invention is made by blending a copolymer (A) powder obtainable by the above-described production process of the present invention, and a blocked isocyanate-type curing agent.

The composition for powder coating material of the present invention may further contain, as the case requires, a non-fluororesin, a curing catalyst, a pigment and/or other additives.

### <Blocked Isocyanate-Type Curing Agent>

As the blocked isocyanate-type curing agent, preferred is one which is solid at room temperature.

As the blocked isocyanate-type curing agent, preferred is one produced by reacting a polyisocyanate obtained by reacting an aliphatic, aromatic or araliphatic diisocyanate with a low molecular weight compound having active hydrogen, with a blocking agent, for masking.

The diisocyanate may, for example, be tolylene diisocyanate, 4,4′-diphenylmethane diisocyanate, xylylene diisocyanate, hexamethylene diisocyanate, 4,4′-methylenebis(cyclohexyl isocyanate), methylcyclohexane diisocyanate, bis(isocyanatomethyl) cyclohexane, isophorone diisocyanate, dimer acid diisocyanate, lysine diisocyanate, etc.

The low molecular compound having active hydrogen may, for example, be water, ethylene glycol, propylene glycol, trimethylolpropane, glycerine, sorbitol, ethylenediamine, ethanolamine, diethanolamine, hexamethylenediamine, isocyanurate, uretdione, a low molecular weight polyester containing a hydroxy group, polycaprolactone, etc.

The blocking agent may, for example, be an alcohol (methanol, ethanol, benzyl alcohol, etc.), a phenol (phenol, cresol, etc.), a lactam (caprolactam, butyrolactam, etc.), an oxime (cyclohexanone, oxime, methyl ethyl ketoxime, etc.).

### <Non-Fluororesin>

The non-fluororesin may, for example, be at least one member selected from the group consisting of acrylic resins, polyester resins, urethane resins, epoxy resins and silicone resins. Among them, from the viewpoint of excellent adhesion to a substrate, and from such a viewpoint that the copolymer (A) is less likely to contaminate the layer to be formed by the non-fluororesin in the curing process, preferred is an acrylic resin or a polyester resin, and particularly preferred is a polyester resin.

The non-fluororesin may be a non-curable resin, or may be one which is curable by a curing agent other than the blocked isocyanate-type curing agent. In a case where the non-fluororesin is a non-curable solid resin, it is permitted to be present as a powder in a powder coating material, so that it will be melted and solidified at the time of curing the powder coating material. In the case of a non-fluororesin curable with a curing agent other than the blocked isocyanate-type curing agent, the curing agent to cure it, is used in combination with the blocked isocyanate-type curing agent. As the non-fluororesin, preferred is a resin which has the same crosslinkable group as the copolymer (A) and which can be cured with a blocked isocyanate-type curing agent.

### (Acrylic Resin)

An acrylic resin is a polymer having units based on a (meth)acrylate. As the acrylic resin, one having a reactive group such as a carboxy group, a hydroxy group or a sulfo group may be mentioned. Such an acrylic resin can improve the dispersibility of a pigment.

The glass transition temperature of the acrylic resin is preferably from 30 to 60° C. When the glass transition temperature is at least the above lower limit value, blocking tends to be less likely. When the glass transition temperature of the acrylic resin is at most the above upper limit value, and the surface smoothness of the cured film will be more excellent.

The number-average molecular weight of the acrylic resin is preferably from 5,000 to 100,000, particularly preferably from 30,000 to 100,000. When the number-average molecular weight of the acrylic resin is at least the above lower limit value, blocking is less likely to occur. When the number-average molecular weight of the acrylic resin is at most the above upper limit value, it is possible to further improve the surface smoothness of the cured film.

The mass average molecular weight of the acrylic resin is preferably from 6,000 to 150,000, more preferably from 40,000 to 150,000, particularly preferably from 60,000 to 150,000. When the mass average molecular weight of the acrylic resin is at least the above lower limit value, blocking is less likely to occur. When the mass average molecular weight of the acrylic resin is at most the above upper limit value, it is possible to further improve the surface smoothness of the cured film.

In a case the acrylic resin has carboxy groups, the acid value of the acrylic resin is preferably from 150 to 400 mgKOH/g. When the acid value of the acrylic resin is at least the above lower limit value, there will be an effect to improve dispersibility of a pigment. When the acid value of the acrylic resin is at most the above upper limit value, the cured film will be excellent in moisture resistance.

### (Polyester Resin)

A polyester resin has polybasic carboxylic acid units and polyhydric alcohol units, and may further have, as the case requires, units (e.g. hydroxycarboxylic acid units, etc.) other than these two types of units.

As the polyester resin, preferred is a linear polymer or a branched polymer having a small number of branches, and particularly preferred is a linear polymer. A branched polymer having many branches tends to have a higher softening point or melting temperature, and therefore, in a case where the polyester resin is a branched polymer, the softening point is preferably at most 200° C. As the polyester resin, preferred is one which is solid at normal temperature, and of which the softening point is from 100 to 150° C.

The number-average molecular weight of the polyester resin is preferably at most 5,000, from such a viewpoint that the melt viscosity of the coating film can be made to be properly low. The mass average molecular weight of the polyester resin is preferably from 2,000 to 20,000, particularly preferably from 2,000 to 10,000, from such a viewpoint that the melt viscosity of the coating film can be made to be properly low. As the polyester resin, preferred is one having a number average molecular weight of at most 5,000 and a mass average molecular weight of from 2,000 to 20,000, and particularly preferred is one having a number average molecular weight of at most 5,000 and a mass average molecular weight of from 2,000 to 10,000.

The polyester resin has reactive groups capable of reacting with a curing agent. At least a portion of a terminal unit of the polymer chain of the polyester resin is preferably a monovalent polybasic carboxylic acid unit or a monovalent polyhydric alcohol unit, and in the former case, a free carboxy group of that unit, or in the latter case, a free hydroxy group of that unit, functions as a reactive group. A unit having a reactive group may be a unit other than a terminal unit. For example, a divalent polyhydric alcohol unit based on a polyhydric alcohol compound having three or more hydroxy groups, is a unit having a free hydroxy group, and therefore, the polyester resin may have a divalent or higher valent unit having such a reactive group.

As the reactive groups in the polyester resin, from the viewpoint of excellent water resistance, alkali resistance and acid resistance, of the cured film, hydroxy groups are preferred. A polyester resin usually has hydroxy groups and carboxy groups, and as the polyester resin, preferred is one which mainly has hydroxy groups.

The hydroxy value of the polyester resin is preferably from 20 to 100 mgKOH/g, particularly preferably from 20 to 80 mgKOH/g. The acid value is preferably from 1 to 80 mgKOH/g, particularly preferably from 3 to 50 mgKOH/g.

The hydroxy value and acid value are measured in accordance with JIS K0070 (1992 year edition).

As the polyester resin, in view of excellent adhesion to the cured layer (the cured fluororesin layer described later) formed by the copolymer (A) in the case where the cured film becomes a film having a two-layer structure, in view of excellent impact resistance of the cured film and in view of excellent dispersibility of a pigment, preferred is a polyester resin having units based on a C₈₋₁₅ aromatic polybasic carboxylic acid and units based on a C₂₋₁₀ polyhydric alcohol.

As the polybasic carboxylic acid units, preferred are units based on a C₈₋₁₅ aromatic polybasic carboxylic acid. The C₈₋₁₅ aromatic polybasic carboxylic acid is a compound having an aromatic ring and two or more carboxy groups, wherein the carboxy groups are bonded to carbon atoms of the aromatic ring. Further, it may be an anhydride wherein two carboxyl groups have a dehydrated structure.

As the aromatic ring, a benzene ring or a naphthalene ring is preferred, and a benzene ring is particularly preferred. In the case of the benzene ring, two may be present in one molecule.

The number of carboxy groups in the aromatic polybasic carboxylic acid is preferably from 2 to 4, particularly preferably 2.

The C₈₋₁₅ aromatic polybasic carboxylic acid may, for example, be phthalic acid, isophthalic acid, terephthalic acid, naphthalene dicarboxylic acid, trimellitic acid, pyromellitic acid, phthalic anhydride, etc.

As the polybasic carboxylic acid units, isophthalic acid units are preferred, since the cured film will thereby be excellent in weather resistance.

As the polyhydric alcohol units, preferred are units based on a C₂₋₁₀ polyhydric alcohol. As the polyhydric alcohol, preferred is an aliphatic polyhydric alcohol or an alicyclic polyhydric alcohol, and an aliphatic polyhydric alcohol is particularly preferred. The number of hydroxy groups in the polyhydric alcohol is preferably from 2 to 4, particularly preferably 2.

The C₂₋₁₀ polyhydric alcohol may, for example, be ethylene glycol, diethylene glycol, triethylene glycol, 1,2-propanediol, 1,3-propanediol, 1,3-butanediol, 1,4-butanediol, 1,5-pentanediol, neopentyl glycol, spiro glycol, 1,10-decanediol, 1,4-cyclohexanedimethanol, trimethylolethane, trimethylolpropane, glycerin, pentaerythritol, etc.

As the polyhydric alcohol units, since adhesion to a substrate is excellent and flexibility is also excellent, whereby even if the thermal history (thermal cycling) is exerted, in a case where the cured film becomes a film having a two-layer structure, delamination of a cured layer formed by the copolymer (A) is less likely to occur, preferred are units based on a C₃₋₈ polyhydric alcohol, and particularly preferred are units based on a C₄₋₆ polyhydric alcohol.

As the polyhydric alcohol, preferred is neopentyl glycol, 1,2-pentanediol, 1,5-pentanediol, trimethylolpropane, etc., and from the viewpoint of availability, particularly preferred is neopentyl glycol or trimethylol propane.

In order to facilitate formation of a cured film of a two layer structure by layer separation of a layer to be formed from the copolymer (A) and a layer to be formed from a non-fluororesin in the melting and curing process of the powder coating material, the polyester resin preferably has a proper ester group concentration and aromatic ring concentration.

The ester group concentration is one having the content of ester groups in the polyester resin represented by mass %, and it can be obtained from the following formula (1).

Ester group concentration (mass %)=2m/[(a+b)×m+a] (1)

m: an average value of the number of units in the polyester resin, as calculated from an average value of molecular weights of the respective units and a value of the number-average molecular weight of the polyester resin.

a: an average value of the number of carbon atoms in the polyhydric alcohol units.

b: an average value of the number of carbon atoms in the polybasic carboxylic acid units.

The ester group concentration in the polyester resin is preferably from 20 to 60 mass %, more preferably from 25 to 50 mass %, particularly preferably from 30 to 40 mass %.

The aromatic ring concentration is one having the content of aromatic rings in the polyester resin represented by mmol/g, and it can be calculated from the following formula (2).

Aromatic ring concentration (mmol/g)=[(total number (mol) of aromatic rings in raw materials used for obtaining the polyester resin)/(total weight (g) of the raw materials used for obtaining the polyester resin)]×1,000 (2)

The aromatic ring concentration in the polyester resin is preferably from 20 to 35 mmol/g, more preferably from 22 to 34 mmol/g, particularly preferably from 25 to 33 mmol/g.

### (Urethane Resin)

The urethane resin may be a mixture obtained by mixing, or a resin obtained by reacting, a polyol (acrylic polyol, polyether polyol, propylene glycol, propylene oxide, etc.) and an isocyanate compound. As the urethane resin, it is preferred to use a solid hydroxy terminated prepolymer which can be powdered, or a powder coating material consisting of a powder polyol (acrylic polyol, polyether polyol) and a powdered isocyanate compound.

### (Epoxy Resin)

The epoxy resin may, for example, be a bisphenol A type epoxy resin, a bisphenol F type epoxy resin, etc.

### (Silicone Resin)

The silicone resin may be one which has a branched structure, which has a silanol group (Si—OH) as a reactive group, which may be cured by dehydration condensation with one another, and which is capable of forming a cured film of a three-dimensional crosslinked structure after curing. Further, a relatively low molecular weight silicone resin (modified silicone resin intermediate) may be used in combination with another thermosetting resin (alkyd resin, polyester resin, epoxy resin, acrylic resin, etc.).

### <Curing Catalyst>

The curing catalyst is one to promote a curing reaction and to impart excellent chemical properties and physical properties to the cured film.

As the curing catalyst, preferred is a tin catalyst (tin octylate, tributyltin laurate, dibutyltin dilaurate, etc.).

As the curing catalyst, one type may be used alone, or two or more types may be used in combination.

### <Pigment>

As the pigment, preferred is at least one member selected from the group consisting of luster pigment, rust-preventive pigment, coloring pigment and extender pigment.

The luster pigment is a pigment to let a cured film shine. The luster pigment may, for example, be aluminum powder, nickel powder, stainless steel powder, copper powder, bronze powder, gold powder, silver powder, mica powder, graphite powder, glass flakes, flake-like iron oxide powder, etc.

A rust-preventive pigment is a pigment to prevent corrosion or modification of a substrate, for the substrate which is required to have rust resistance. As the rust-preventive pigment, preferred is a lead-free anticorrosive pigment presenting less impact on the environment. The lead-free anticorrosive pigment may, for example, be zinc cyanamide, zinc oxide, zinc phosphate, calcium magnesium phosphate, zinc molybdate, barium borate, zinc calcium cyanamide, etc.

The coloring pigment is a pigment for coloring a cured film. The coloring pigment may, for example, be titanium oxide, carbon black, iron oxide, phthalocyanine blue, phthalocyanine green, quinacridone, isoindolinone, benzimidazolone, dioxazine, etc.

The extender pigment is a pigment to improve the hardness of a cured film and to increase the thickness of the cured film. Further, it is preferably incorporated from such a viewpoint that when the substrate is cut, the cut surface of the cured film can thereby be made clean. The extender pigment may, for example, be talc, barium sulfate, mica, calcium carbonate, etc.

As the titanium oxide, preferred is one having surface treatment applied so as to make a photocatalytic reaction hardly to proceed, and specifically, preferred is titanium oxide surface-treated with silica, alumina, zirconia, selenium, an organic component (polyol, etc.), etc. Particularly preferred is titanium oxide having the titanium oxide content adjusted by such surface treatment to be from 83 to 90 mass %. When the titanium oxide content is at least the above lower limit, the cured film will be excellent in whiteness. When the titanium oxide content is at most the above upper limit value, the cured film is less likely to be degraded.

### <Other Additives>

Additives other than the above may, for example, be a light stabilizer, an ultraviolet absorber, a polymerization inhibitor, a matting agent (ultrafine synthetic silica, etc.), surfactant (nonionic, cationic, or anionic), a leveling agent, a surface modifier (to improve the surface smoothness of the cured film), a degassing agent (having a function to discharge out of a coating film air included in the powder, a blocking agent, moisture, etc. coming out of the curing agent so as not to remain inside of the cured film, and usually, it is solid, but becomes to have a very low viscosity when melted), a filler, a heat stabilizer, a thickener, a dispersing agent, an antistatic agent, a rust inhibitor, a silane coupling agent, an antifouling agent, a low pollution treatment agent, a water repellent, an oil repellent, etc.

The light stabilizer in the composition for powder coating material, is one to protect the resin (the copolymer (A), the non-fluororesin, etc.) in the cured film from ultraviolet rays.

As the light stabilizer, a hindered amine light stabilizer is preferred, since it tends to be easily localized in a layer formed by a non-fluororesin in the melting and curing process of the powder coating material. As the hindered amine light stabilizer, the same ones as exemplified in compound (B) may be mentioned.

The ultraviolet absorber is not particularly limited. In a case where the cured film has a two-layer structure, in order to let the ultraviolet absorber be easily localized in a layer to be formed by the copolymer (A) in the melting and curing process of the powder coating material, it is preferred to select a ultraviolet absorber which tends to be easily localized in the layer to be formed by the copolymer (A) in consideration of e.g. the physical properties of the ultraviolet absorber. For example, as between a lipophilic ultraviolet absorber and a hydrophilic ultraviolet absorber, the lipophilic ultraviolet absorber tends to be easily localized in the layer to be formed by the copolymer (A). Further, the affinity for the copolymer (A) may sometimes be different by a difference in the type (the difference in the chemical structure) or in the physical properties (molecular weight, melting point, boiling point, etc.) of ultraviolet absorbers.

As the ultraviolet absorber, either an organic ultraviolet absorber or an inorganic ultraviolet absorber may be used. As the ultraviolet absorber, one type may be used alone, or two or more types may be used in combination.

The organic ultraviolet absorber may, for example, be a salicylic acid ester-type ultraviolet absorber, a benzotriazole-type ultraviolet absorber, a benzophenone-type ultraviolet absorber, a cyanoacrylate-type ultraviolet absorber, etc.

As the organic ultraviolet absorber, preferred is a compound having a molecular weight of from 200 to 1,000. When the molecular weight is at least 200, it is less likely to volatilize in the melting and curing process of the powder coating material and can remain in the cured film. When the molecular weight is at most 1,000, it can remain in a layer to be formed by the copolymer (A) in a case where the cured film becomes to be a film having a two-layer structure.

As the organic ultraviolet absorber, preferred is a compound having a melting point of from 50 to 150° C. When the melting point is at least 50° C., it is less volatile in the melting and curing process of the powder coating material, and can remain in the cured film. When the melting point is at most 150° C., it is readily meltable in the melting and curing process of the powder coating material, and can remain in a layer to be formed by the copolymer (A) in a case where the cured film becomes a film having a two-layer structure.

As the organic ultraviolet absorber, preferred is a compound with a volatilization temperature of from 180 to 400° C., and particularly preferred is a compound with a volatilization temperature of from 220 to 350° C. In the melting and curing process of the powder coating material, a temperature condition of from 150 to 220° C. is required, but, as long as it is within the above range, it is less likely to volatilize and tends to remain in a layer to be formed by the copolymer (A) in a case where the cured film becomes a film having a two-layer structure.

The inorganic ultraviolet absorber may, for example, be a filler-type inorganic ultraviolet absorber containing a ultraviolet absorbing oxide (zinc oxide, cerium oxide, etc.).

As the inorganic ultraviolet absorber, preferred are composite particles of zinc oxide and titanium oxide, composite particles of cerium oxide and titanium oxide, composite particles of zinc oxide and cerium oxide, composite particles of titanium oxide, zinc oxide and cerium oxide, etc.

The polymerization inhibitor may, for example, be hydroquinone-type, catechol-type, anthraquinone-type, phenothiazine-type, hydroxy toluene-type, etc. Among them, from the viewpoint of easily suppressing an increase of the molecular weight of the copolymer (A), hydroquinone-type polymerization inhibitors are preferred. Among the hydroquinone-type polymerization inhibitors, hydroquinone is preferred.

### <Blend Amount of Each Component>

In the composition for powder coating material of the present invention, the blend amount of the blocked isocyanate-type curing agent is such an amount that the molar ratio of isocyanate groups to crosslinkable groups in the copolymer (A) powder would be preferably from 5 to 2.0, more preferably from 0.7 to 1.5. When the molar ratio is at least the above lower limit value, the degree of curing of the coating film will be high, and adhesion between the cured layer formed by the copolymer (A) and the cured layer formed by a non-fluororesin, hardness and chemical resistance of the cured film, etc. will be excellent. When the molar ratio is at most the above upper limit value, the cured film will be less likely to become brittle, and moreover, the cured film will be excellent in heat resistance, chemical resistance, moisture resistance, etc.

In the case of blending a non-fluororesin, the blend amount of the non-fluororesin is from 10 to 400 parts by mass, preferably from 15 to 350 parts by mass, more preferably from 20 to 300 parts by mass, to 100 parts by mass of the copolymer (A) powder. When the blend amount of the non-fluororesin is at least the lower limit value in the above range, it is possible to suppress the cost. Further, even if the substrate to be coated is an aluminum-made substrate or the like which has been treated with a chromium-free chemical conversion treatment agent, it is possible to secure the adhesion between the cured film and the substrate. When the blend amount of the non-fluororesin is at most the upper limit value in the above range, the cured film will be excellent in weather resistance.

In a case where the composition for powder coating material contains a curing catalyst, the blend amount of the curing catalyst is preferably from 0.001 to 5.0 parts by mass to 100 parts by mass of the copolymer (A) powder. When the blend amount of the curing catalyst is at least the lower limit value in the above range, the catalytic effect tends to be sufficiently obtainable. When the blend amount of the curing catalyst is at most the upper limit value in the above range, a gas such as air included in the powder coating material in the melting and curing process of the powder coating material, tends to be easily discharged, and a decrease in the heat resistance, weather resistance and water resistance of the cured film to be caused by remaining gas, will be less.

In a case where the composition for powder coating material contains a pigment, the blend amount of the pigment may be suitably set depending upon the desired color tone, the strength of the coating film, etc. and is not particularly limited, but it is, typically, from 10 to 200 parts by mass to 100 parts by mass of the copolymer (A) powder.

### <Methods for Producing Composition for Powder Coating Material>

The composition for powder coating material may be produced by known methods. For example, the following methods may be mentioned. Here, the mixing and melt-kneading in the following methods are carried out under such a condition (for example, the melt-kneading temperature) that a blocked isocyanate-type curing agent is not de-blocked.

Method I: A method of mixing the copolymer (A) powder and a powder of other raw materials (a blocked isocyanate-type curing agent, etc.).

Method II: A method of mixing the copolymer (A) powder and solid-form other raw materials (a blocked isocyanate-type curing agent, etc.) and pulverizing the obtained mixture into powder.

Method III: A method of melt-kneading the copolymer (A) powder and solid-form other raw materials (a blocked isocyanate-type curing agent, etc.), followed by cooling to obtain a massive product, which is then pulverized into powder.

Among these methods, the method III is preferred in that it is thereby possible to obtain a cured film excellent in homogeneity since the respective components are uniformly distributed in the obtainable powder.

Mixing of the raw materials can be carried out by using a known mixer. The type of the mixer may, for example, be a high-speed mixer, a V-type mixer, an inversion mixer, etc.

Melt-kneading may be carried out by using various types of an extruder, such as, uniaxial, biaxial, planetary gear, etc. The mixture of various components are kneaded in a heated and melted state, to homogenize the respective components. The melt-kneaded product extruded is preferably cooled and formed into pellets.

Pulverization of the pellets may be carried out by using a known pulverizer. The type of the pulverizer may, for example, be a pin mill, a hammer mill, a jet mill, etc.

After pulverization, it is preferred to conduct classification. In a case where classification is conducted, it is preferred to remove at least either particles with particle sizes of less than 10 μm or particles with particle sizes exceeding 100 μm.

The particle size of particles contained in the composition for powder coating material is, for example, preferably from about 25 to 50 μm at a 50% average volume particle size distribution.

The particle size of the particles is measured by using a commonly employed particle size measuring apparatus. The type of the particle size measuring apparatus may, for example, be a type to capture the potential change at the time of passing through a pore, a laser diffraction system, an image judgment type, a sedimentation rate measurement system, etc.

### [Powder Coating Material]

The powder coating material of the present invention comprises the above-described composition for powder coating material of the present invention.

The powder coating material may be one wherein the above-described composition for powder coating material is used as it is, as a powder coating material, or one wherein additives such as a non-fluororesin, a pigment, a curing catalyst, a surface modifier, etc. are added as the case requires, or one wherein two or more compositions for powder coating material different in the types or contents of components are mixed.

The powder coating material may be one having the above-described composition for powder coating material or a mixture containing such a composition for powder coating material melt-kneaded, and then powdered. Otherwise, the powder coating material may be one having two or more powder coating materials thus melt-kneaded and powdered, further mixed (one so-called dry-blended).

The details of the additives are the same as those described with respect to the above-mentioned composition for powder coating material.

### <Method for Producing Powder Coating Material>

For the powder coating material, the above composition for powder coating material may be used as it is, as a powder coating material, or it may be produced by incorporating, as the case requires, additives such as a non-fluororesin, a pigment, a curing catalyst, a surface modifier, etc. or may be produced by mixing two or more compositions for powder coating material different in the types or contents of components. Otherwise, the powder coating material may be produced by melt-kneading the composition for powder coating material or a mixture containing the composition for powder coating material, followed by powdering. Further, the powder coating material may be prepared by mixing two or more powder coating materials. Further, as in the case of the production of the composition for powder coating material, mixing or melt kneading at the time of producing a powder coating material is carried out in such a condition that a blocked isocyanate-type curing agent will not be deblocked.

Mixing of components is similar to the mixing of raw materials in the method for production of the composition for powder coating material.

Further, it is preferred that the obtained mixture is melt-kneaded, pelletized, pulverized and classified. The details of the melt-kneading, the pulverization of pellets and the classification are the same as those in the above described method for production of the composition for powder coating material.

### [Coated Article]

A coated article of the present invention has a cured film formed from the above-described powder coating material of the present invention, on the surface of a substrate.

The cured film contains a crosslinked copolymer (A) formed by a reaction of the copolymer (A) and the blocked isocyanate-type curing agent. The cured copolymer (A) in the cured film will be hereinafter referred to also as the “cured fluororesin”.

Further, in a case where the powder coating material contains the copolymer (A), a non-fluororesin cross-linkable with a blocked isocyanate-type curing agent, and the blocked isocyanate-type curing agent, the cured film will contain a cured copolymer (A) and a cured non-fluororesin. In a case where a curable non-fluororesin is one curable with a curing agent other than a blocked isocyanate-type curing agent, and the curing agent other than the blocked isocyanate-type curing agent is a curing agent to cure only, the cured film will contain a cured resin on one hand and a non-cured solid resin on other hand.

The composition for coating material or the powder coating material of the present invention preferably contains the copolymer (A), the crosslinkable non-fluororesin and a curing agent to crosslink them. In this case, the cured film will contain a cured fluororesin being a cross-linked copolymer (A) and a crosslinked non-fluororesin (hereinafter referred to also as a cured non-fluororesin).

The material for the substrate is not particularly limited, and may, for example, be an inorganic, organic or organic-inorganic composite material. As the inorganic material, concrete, natural stone, glass, metal (iron, stainless steel, aluminum, copper, brass, titanium, etc.), etc. may be mentioned. As the organic material, plastic, rubber, adhesive, wood, etc. may be mentioned. As the organic-inorganic composite material, fiber-reinforced plastic, resin-reinforced concrete, fiber-reinforced concrete, etc. may be mentioned.

Among them, a metal is preferred, and aluminum is particularly preferred. An aluminum substrate is excellent in corrosion resistance and light in weight, and has an excellent performance in building material applications.

The shape, size, etc. of the substrate, are not particularly limited.

Examples of the substrate include transportation equipment (automobiles, trains, aircrafts, etc.), civil engineering members (bridge members, towers, etc.), industrial equipment (waterproof material sheets, tanks, pipes, etc.), building materials (building exterior, doors, window members, monuments, poles, etc.), road members (median strip of the road, guardrails, soundproof walls, etc.), communication equipment, electrical components, electronic components, solar cell module top sheets, solar cell module back sheets, etc.

The thickness of the cured film is not particularly limited, but it is usually at most 200 μm. In applications where a high level of weather resistance is required, such as an outdoor unit of air conditioner that is installed on the seafront, a traffic signal pole, a sign board, etc., it is preferably from 100 to 200 μm.

The water contact angle of the cured film is preferably from 1 to 55°, particularly preferably from 3 to 50°. When the water contact angle of the cured film is at least the above lower limit value, the cured film is less likely to be corroded by bird droppings or dead bodies of insects, and further, generation of mold on the cured film surface is suppressed (generation of mold leads to poor appearance). When the water contact angle of the cured film is at most the above upper limit value, the stain resistance will be excellent.

In a case where the powder coating material contains a non-fluororesin, a cured film to be formed by the powder coating material may be a single layer structure consisting of a mixture of a cured fluororesin and a curing non-fluororesin, or a two-layer structure wherein a cured fluororesin and a cured non-fluororesin form separate layers. In the case of the two-layer structure, a cured film further excellent in water resistance, chemical resistance and weather resistance will be formed. As a method of forming a cured film having a two-layer structure, for example, the method disclosed in WO2014/002964 may be mentioned.

The coated article of the present invention is preferably a building member having the above-described cured film on the surface of an aluminum substrate for a sash or curtain wall, since yellowing of the coating film is less likely, a lightly tinted coating color can be expressed, and further, a high brightness feeling tends to be obtainable also for a metallic coating color formed by blending aluminum flakes, etc. The aluminum substrate for a sash or curtain wall may, for example, be an aluminum panel for a curtain wall, an aluminum frame for a curtain wall, an aluminum window frame, etc.

### <Method for Producing the Coated Article>

The coated article is produced by forming a cured film by the above-described powder coating material, on the surface of a substrate.

Formation of the cured film is conducted, for example, by applying a heated and melted powder coating material onto the substrate surface, to let it undergo a curing reaction. After the curing reaction, the heated and melted powder coating material is cooled and solidified to room temperature (20 to 25° C.). Thus, the cured film is formed.

The method of applying a heated and melted powder coating material on the substrate surface, may be a method of heating and melting the powder coating material, followed by depositing it on a substrate surface, or it may be a method of depositing the powder coating material onto the substrate surface, followed by heating and melting it. In the case of the method of heating and melting the powder coating material, followed by depositing it onto the substrate surface, since the curing reaction progresses at the same time as the powder coating material is heated and melted, it is preferred that the heating and melting are conducted immediately before the deposition.

The heating temperature (hereinafter referred to as “baking temperature”) and the heating holding time (hereinafter referred to as “baking time”) to heat and melt the powder coating material, and to maintain the molten state for a predetermined time, are suitably set depending upon the type and composition of raw material components of the powder coating material, the desired thickness of a cured film, etc. Especially, the baking temperature is preferably set depending on the reaction temperature of the curing agent to be used. The baking temperature in the case of using a blocked polyisocyanate-type curing agent as the curing agent, is preferably from about 170 to 210° C. The baking time is preferably from 5 to 120 minutes, particularly preferably from 10 to 60 minutes.

Cooling after the baking may be either quenching or annealing, but annealing is preferred in that interfacial peeling due to the difference in cure shrinkage between the cured fluororesin layer and the cured non-fluororesin layer, is less likely to occur.

As the coating method, it is possible to use an electrostatic coating method, an electrostatic spraying method, an electrostatic immersion method, a misting method, a flow immersion method, a blowing method, a spraying method, a thermal spraying method, a plasma spraying method, etc.

An electrostatic coating method using a powder coating gun is preferred from such a viewpoint that even when a cured film is thinned, the cured film has excellent smoothness, and furthermore, the cured film is excellent in concealing properties.

The powder coating gun may, for example, be a corona charging type coating gun or a frictional electrification type coating gun. The corona charging type coating gun is one to spray the powder coating material subjected to corona discharge treatment, and the frictional electrification type coating gun is one to spray the powder coating material subjected to friction charging treatment.

As a method for forming a relatively thick cured film, a flow immersion method is preferred. In the flow immersion method, it is preferred that in a fluidized bed in which the powder that is fluidized as carried by a gas such as air, is accommodated, a substrate having its coating surface heated to a temperature of at least the melting temperature of the powder coating material, is immersed to let the powder deposit and be melted on the coating surface of the substrate, thereby to let a coating film with a predetermined thickness be formed on the substrate, and then, the coated substrate is taken out from the fluidized bed, and as the case requires, the coated film is maintained in the molten state for a predetermined time, followed by cooling to let the coated film in the molten state be cooled and solidified, to obtain the substrate having a cured film formed. The thickness of the cured film to be formed by the flow immersion method, is, although not particularly limited, preferably from 100 to 1,000 μm.

### EXAMPLES

In the following, the present invention will be described in detail with reference to Examples. However, the present invention is not limited to these Examples.

In the following description, unless otherwise described, “%” is “mass %”.

Among the following Ex. 1 to 18, Ex. 1 to 4, Ex. 7 to 10 and Ex. 13 to 16 are Examples of the present invention, and Ex. 5 to 6, Ex. 11 to 12 and Ex.17 to 18 are Comparative Examples.

The evaluation methods used in Examples are shown below.

### [Evaluation Methods]

<Measurement of pH>

The pH of a copolymer (A) solution was measured as follows.

10 g of a copolymer (A) solution having insoluble components removed by filtration using diatomaceous earth as the filtering material, and 30 g of methyl isobutyl ketone were put in a glass container of 100 mL and dissolved until the solution became homogeneous. Then, the dissolved solution was poured into a separatory funnel of 300 mL, and further, 30 g of methyl isobutyl ketone was charged. Then, 60 g of deionized water was charged, and the separatory funnel was manually shaken for 1 minute, and then allowed to stand still until separation into two layers. The aqueous layer was separated, and the pH at 25° C. of the aqueous layer was measured and adopted as the pH of the copolymer (A) solution.

### <Measurement of APHA Value>

Measured in accordance with ASTM D1209.

### <Stability of Copolymer (A) Solution>

The stability of the copolymer (A) solution was evaluated as follows.

The number average molecular weight (initial number average molecular weight) of the copolymer (A) in the copolymer (A) solution immediately after removal of insoluble components, was measured by GPC (manufactured by Tosoh Corporation, HLC-8220).

100 g of the copolymer (A) solution was put in a heat-resistant container and left to stand in a constant temperature bath at 70° C. under RH 50%, and after 14 days, the number average molecular weight of the copolymer (A) in the copolymer (A) solution was measured in the same manner as described above.

The increasing rate of the number average molecular weight after 14 days to the initial number average molecular weight (number average molecular weight after 14 days/initial number average molecular weight x 100 (%)) was obtained.

Further, the discoloration degree of the copolymer (A) solution after 14 days to the initial copolymer (A) solution, was visually evaluated.

From the increasing rate of the number average molecular weight and the discoloration degree, evaluation was made by the following standards.

A: The increasing rate of the number average molecular weight after 14 days was less than 150%, and no significant discoloration (yellowing or cloudiness) was observed.

B: The increasing rate of the number average molecular weight after 14 days was less than 150%, but significant discoloration (yellowing or cloudiness) was observed.

C: The increasing rate of the number average molecular weight after 14 days was 150% or more, but no significant discoloration (yellowing or clouding) was observed.

D: The increasing rate of the number average molecular weight after 14 days was 150% or more, and significant discoloration (yellowing or cloudiness) was also observed.

### <Non-Volatile Content of Copolymer (A) Powder>

The non-volatile content (mass %) of the copolymer (A) powder was obtained by measuring the heating residue in accordance with JIS K5601-1-2 (2009 enacted).

### <Average Particle Size>

By a laser diffraction particle size distribution analyzer (manufactured by Sympatec Inc., product name: Helos-Rodos), the particle size distribution on a volume basis of the powder was measured, and the 50% diameter was obtained and the obtained value was taken as the average particle size.

### <Appearance (Coloration) of the Cured Film>

The gloss value of the surface of a cured film was measured by using PG-1M (gloss meter manufactured by Nippon Denshoku Industries Co., Ltd.). Further, the color of the cured film was visually observed, and presence or absence of significant yellowing was evaluated by using, as a sample plate, a coated plate obtained from a polyester powder coating material prepared with the following powder coating material formulation. From these results, the appearance (coloration) was evaluated by the following standards.

∘ (good): The gloss was at least 70, and no significant yellowing was observed.

x (bad): The gloss was less than 70, and significant yellowing was observed.

### —Polyester-Type Powder Coating Material—

52.0 g of a polyester resin (manufactured by DAICEL-ALLNEX LTD., CRYLCOAT (registered trademark) 4890-0, mass-average molecular weight: 4,400, number-average molecular weight: 2,500, hydroxy value: 30 mgKOH/g), 7.6 g (INDEX=1) of a blocked isocyanate-type curing agent (manufactured by Evonik Industries, trade name: Vestagon B1530), 0.4 g of benzoin as a degassing agent, 1.0 g of a surface modifier (manufactured by BYK, trade name: BYK-360P), 0.0042 g of dibutyltin dilaurate as a curing catalyst, and 32.1 g of titanium dioxide as a coloring agent (manufactured by DuPont, trade name: Ti-Pure R960), were mixed by using a high speed mixer, with each component being in a powder state. The obtained mixture was melt-kneaded by means of a biaxial extruder (manufactured by Thermo Prism Ltd., 16 mm extruder) at a barrel setting temperature of 120° C., to obtain pellets. The obtained pellets were pulverized at room temperature by using a pulverizer and classified by mesh to obtain a powder coating material having an average particle size of about 40 μm.

This powder coating material was electrostatically coated on one surface of a chromate treated aluminum plate by electrostatic coating machine (manufactured by Onoda Cement Co. Ltd., GX3600C) and held in an atmosphere of 200° C. for 20 minutes. Then, by cooling to room temperature, an aluminum plate having a cured film with a thickness of from 55 to 65 μm was obtained. The obtained cured film-coated aluminum plate was used as a sample plate.

### <Appearance of Cured Film (Smoothness)>

The surface smoothness of a cured film was judged by using standard plates for visual judgment of smoothness by PCI (Powder Coating Institute). The standard plates are ten plates of from 1 to 10, whereby the larger the numeral, better the smoothness. Further, surface irregularities, cissing and poor wettability to a substrate were visually evaluated. From these results, appearance (smoothness) was evaluated by the following standards.

∘ (good): The cured film was excellent in surface smoothness (the numeral of the standard plate equal in surface smoothness was 6 or higher), and surface irregularities, cissing, poor wettability to the substrate, etc. were not observed.

x (bad): The cured film was poor in surface smoothness (the numeral of the standard plate equal in surface smoothness was 5 or lower), and surface irregularities, cissing, poor wettability to the substrate, etc. were observed.

### Ex. 1

(1. Production of Copolymer (A) Solution)

In a stainless steel pressure-resistant container equipped with a stirrer having an inner volume of 500 L, a monomer mixture of 10.0 kg of tert-butyl ether (t-BuVE), 11.0 kg of hydroxybutyl vinyl ether (HBVE) and 29.0 kg of vinyl pivalate (VPV), 57.5 kg of xylene, 16.2 kg of ethanol, 0.46 kg of potassium carbonate, 1.15 kg of hydrotalcite (manufactured by Kyowa Chemical Industry Co., Ltd., KW500, particle size: 45 μm or less 38%, 45 to 105 μm 35%, 75 to 106 μm 21%, 106 to 500 μm 6%), 0.7 kg of a 50 mass % xylene solution of tert-butyl peroxypivalate (PBPV), and 65.0 kg of chlorotrifluoroethylene (CTFE) were introduced. Then, the temperature was gradually raised, and, after reaching 55° C., held for 20 hours. Then, it was raised to 65° C. and held for 5 hours. After cooling, from the obtained suspension, insoluble components were removed by filtration, to obtain a copolymer (A) solution (a).

(2. Production of Copolymer (A) Powder)

The copolymer (A) solution (a) was supplied from an inlet of a thin film vacuum evaporator “EXEVA” (trade name: manufactured by Shinko Pantec Co., Ltd.) so that the feeding rate became 30 kg/hour, and the solvent in the copolymer (A) solution (a) was removed to obtain a copolymer (A) powder (a). The degree of vacuum in the thin film vacuum evaporator was set to be −0.09 MPa (gauge pressure), the temperature of the heat transfer medium was set to be 95° C., the stirring rotation speed of the thin-film vacuum evaporator was set to be 400 rpm, and the stirring rotation speed of the molten resin discharge screw was set to be 300 rpm. The non-volatile content of the obtained copolymer (A) powder (a) was 99.8%.

### Ex. 2

In the same manner as in Ex. 1 except that in Ex. 1, 1.15 kg of hydrotalcite (manufactured by Kyowa Chemical Industry Co., Ltd., product name; KW500, particle size: 45 μm or less 38%, 45 to 74 μm 35%, 75 to 106 μm 21%, 106 to 500 μm 6%) was changed to 5.75 kg, a copolymer (A) solution (b) was produced, and a copolymer (A) powder (β) was obtained. The non-volatile content of the copolymer (A) powder (β) was 99.9%.

### Ex. 3

In the same manner as in Ex. 1, except that in Ex. 1, 0.46 kg of potassium carbonate was changed to 1.04 kg, a copolymer (A) solution (c) was produced, and a copolymer (A) powder (y) was obtained. The non-volatile content of the copolymer (A) powder (y) was 99.9%.

### E. 4

In the same manner as in Ex. 1, except that in Ex. 1, 0.46 kg of potassium carbonate was changed to 0.46 kg of the following T144, a copolymer (A) solution (d) was produced, and a copolymer (A) powder (δ) was obtained. The non-volatile content of the copolymer (A) powder (δ) was 99.9%.

T144: a hindered amine-type light stabilizer, manufactured by BASF, Tinuvin (registered trademark) 144.

### Ex. 5

In the same manner as in Ex. 1, except that in Ex. 1, 0.46 kg of potassium carbonate was changed to 6.3 kg, and hydrotalcite (manufactured by Kyowa Chemical Industry Co., Ltd., product name; KW500, particle size: 45 μm or less 38%, 45 to 74 μm 35%, 75 to 106 μm 21%, 106 to 500 μm 6%) was not added, a copolymer (A) solution (e) was produced, and the copolymer (A) powder (ε) was obtained. The non-volatile content of the copolymer (A) powder (ε) was 99.9%.

### Ex. 6

In the same manner as in Ex. 1, except that in Ex. 1, 0.46 kg of potassium carbonate was changed to 0.05 kg, and 1.15 kg of hydrotalcite (manufactured by Kyowa Chemical Industry Co., Ltd., product name; KW500, particle size: 45 μm or less 38%, 45 to 74 μm 35%, 75 to 106 μm 21%, 106 to 500 μm 6%) was changed to 0.05 kg, a copolymer (A) solution (f) was produced, and a copolymer (A) powder (A) was obtained. The non-volatile content of the copolymer (A) powder (8) was 99.9%.

The type and amount of the compound (B) and the amount of hydrotalcite used in Ex. 1 to 6, as well as the evaluation results of the pH, APHA value and stability of the copolymer (A) solution, are shown in Table 1.

TABLE 1

| | Ex. 1 | Ex. 2 | Ex. 3 | Ex. 4 | Ex. 5 | Ex. 6 |
|---|---|---|---|---|---|---|
| Copolymer (A) | (a) | (b) | (c) | (d) | (e) | (f) |
| solution | | | | | | |
| Compound (B) | K₂CO₃ | K₂CO₃ | K₂CO₃ | T-144 | K₂CO₃ | K₂CO₃ |
| Amount of | 0.4 | 0.4 | 0.9 | 0.4 | 5.5 | 0.04 |
| compound (B) | | | | | | |
| to 100 parts by | | | | | | |
| mass of monomer | | | | | | |
| mixture (parts | | | | | | |
| by mass) | | | | | | |
| Amount of | 1.0 | 5.0 | 1.0 | 1.0 | — | 0.04 |
| hydrotalcite to 100 | | | | | | |
| parts by mass of | | | | | | |
| monomer mixture | | | | | | |
| (parts by mass) | | | | | | |
| pH | 4.2 | 4.5 | 5.2 | 4.5 | 6.7 | 3.7 |
| APHA value | 40 | 32 | 55 | 50 | 350 | 310 |
| Stability | A | A | A | A | B | D |
| Copolymer (A) | (α) | (β) | (γ) | (δ) | (ε) | (θ) |
| powder | | | | | | |

### Ex. 7 to 12

<Production of Titanium Oxide-Containing Compositions for Powder Coating Material>Using the copolymer (A) powders (a) to (8) obtained in the above Ex. 1 to 6, respectively, the compositions (a1) to (81) for powder coating material were produced.

That is, 116 g of the copolymer (A) powder, 28 g (INDEX =1) of a blocked isocyanate-type curing agent (manufactured by Evonik Industries, trade name: Vestagon B1530), 0.8 g of benzoin as a degassing agent, 2 g of a surface modifier (manufactured by BYK, trade name: BYK-360P), 0.0042 g of dibutyltin dilaurate as a curing catalyst, and 70 g of titanium dioxide as a coloring agent (manufactured by DuPont, product name: Ti-Pure R960), were mixed by the high-speed mixer with each component being in a powder state. The obtained mixture was melt-kneaded by using a biaxial extruder (manufactured by Thermo Prism Ltd., 16 mm extruder) at a barrel setting temperature of 120° C., to obtain pellets. The obtained pellets were pulverized at room temperature using a pulverizer and classified by mesh to obtain a titanium oxide-containing composition for powder coating material having an average particle size of about 40 μm.

### <Preparation of Test Specimen and Evaluation>

Using the titanium oxide-containing composition for powder coating material obtained in each Ex., a specimen was prepared by the following procedure.

On one surface of a chromate-treated aluminum substrate, the titanium oxide-containing composition for powder coating material was electrostatically coated by using an electrostatic coating machine (manufactured by Onoda Cement Co. Ltd., trade name: GX3600C) and held in an atmosphere of 200° C. for 20 minutes and then cooled, to obtain a test specimen having a cured film with a thickness of from 55 to 65 μm formed.

With respect to the obtained test specimen, the appearance (coloration, smoothness) of the cured film was evaluated. The results are shown in Table 2.

TABLE 2

| | Ex. 7 | Ex. 8 | Ex. 9 | Ex. 10 | Ex. 11 | Ex. 12 |
|---|---|---|---|---|---|---|
| Composition for | (α1) | (β1) | (γ1) | (δ1) | (ε1) | (θ1) |
| powder coating | | | | | | |
| material | | | | | | |
| Copolymer (A) | (α) | (β) | (γ) | (δ) | (ε) | (θ) |
| powder | | | | | | |
| Appearance | ∘ | ∘ | ∘ | ∘ | x | x |
| (coloration) | | | | | | |
| Appearance | ∘ | ∘ | ∘ | ∘ | x | x |
| (smoothness) | | | | | | |

### Ex. 13 to 18

### <Production of Compositions for Clear Powder Coating Material>

Using the copolymer (A) powders (a) to (8) obtained in the above Ex. 1 to 6, respectively, compositions (a2) to (82) for powder coating material were produced.

That is, 116 g of the copolymer (A) powder, 28 g (INDEX =1) of a blocked isocyanate-type curing agent (manufactured by Evonik Industries, trade name: Vestagon B1530), 0.8 g of benzoin as a degassing agent, 2 g of a surface modifier (manufactured by BYK, trade name: BYK-360P), and 0.0042 g of dibutyltin dilaurate as a curing catalyst, were mixed by using a high speed mixer with each component being in a powder state. The obtained mixture was melt-kneaded by using a biaxial extruder (manufactured by Thermo Prism Ltd., 16 mm extruder) at a barrel setting temperature of 120° C., to obtain pellets. The obtained pellets were pulverized at room temperature by using a pulverizer and classified by mesh to obtain a composition for clear powder coating material having an average particle size of about 40 μm.

### <Preparation of Test Specimen and Evaluation>

Using the composition for clear powder coating material obtained in each Ex., a test specimen was prepared by the following procedure.

On one surface of a chromate-treated aluminum substrate, the composition for clear powder coating material was electrostatically coated by using an electrostatic coating machine (manufactured by Onoda Cement Co. Ltd., trade name: GX3600C) and held in an atmosphere of 200° C. for 20 minutes, and then cooled to obtain a test specimen having a cured film with a thickness of 55 to 65 μm formed.

With respect to the obtained test specimen, the appearance (coloration, smoothness) of the cured film was evaluated. The results are shown in Table 3.

TABLE 3

| | Ex. 13 | Ex. 14 | Ex. 15 | Ex. 16 | Ex. 17 | Ex. 18 |
|---|---|---|---|---|---|---|
| Composition for | (α2) | (β2) | (γ2) | (δ2) | (ε2) | (θ2) |
| powder coating | | | | | | |
| material | | | | | | |
| Copolymer (A) | (α) | (β) | (γ) | (δ) | (ε) | (θ) |
| powder | | | | | | |
| Appearance | ∘ | ∘ | ∘ | ∘ | x | x |
| (coloration) | | | | | | |
| Appearance | ∘ | ∘ | ∘ | ∘ | x | x |
| (smoothness) | | | | | | |

As shown in the above results, in Ex. 1 to 4, the stability of the copolymer (A) solution obtained in the process for producing the copolymer (A) powder was excellent, whereby significant discoloration of the solution, or significant increase of the copolymer (A) in the solution, was not observed. Further, the cured film formed by using the composition for powder coating material having the obtained copolymer (A) powder blended (i.e. the titanium oxide-containing compositions for powder coating material in Ex. 7 to 10 and the compositions for clear powder coating material in Ex. 13 to 16), showed no significant yellowing and was excellent also in smoothness.

On the other hand, in Ex. 5 wherein the amount of the compound (B) exceeded 5.0 parts by mass to 100 parts by mass of the monomer mixture, and no hydrotalcite was added, and in Ex. 6 wherein each of the amount of the compound (B) and the amount of hydrotalcite was less than 0.05 parts by mass per 100 parts by mass of the monomer mixture, the stability of the copolymer (A) solution was low as compared with in Ex. 1 to 4. Further, the cured film formed by using the composition for powder coating material having the obtained copolymer (A) powder blended (i.e. the titanium oxide-containing compositions for powder coating material in Ex. 11 and 12, and the compositions for clear powder coating material in Ex. 17 and 18) was not satisfactory with respect to the appearance (yellowing, smoothness).

This application is a continuation of PCT Application No. PCT/JP2015/081385, filed on Nov. 6, 2014, which is based upon and claims the benefit of priority from Japanese Patent Application No. 2014-232826 filed on Nov. 17, 2014. The contents of those applications are incorporated herein by reference in their entireties.

What is claimed is:

1. A process for producing a fluoroolefin copolymer powder for powder coating material, characterized by comprising:
a step (I) of polymerizing a monomer mixture comprising the following monomer (a1), the following monomer (a2) and the following monomer (a3) in an organic solvent in the presence of the following compound (B) and hydrotalcite, to obtain a suspension, a step (II) of removing an insoluble component from the suspension, to obtain a fluoroolefin copolymer solution, and
a step (III) of removing the organic solvent from the fluoroolefin copolymer solution to obtain a fluoroolefin copolymer powder in which a non-volatile content is within a range of from 99 to 100 mass %,
wherein in the step (I), the amount of the compound (B) is from 0.05 to 10 parts by mass to 100 parts by mass of the monomer mixture, and the amount of hydrotalcite is from 0.05 to 10 parts by mass to 100 parts by mass of the monomer mixture,
and of the fluoroolefin copolymer solution, the pH is from 3.8 to 6.5, and the APHA value is within a range of from 1 to 200,
Monomer (a1): a fluoroolefin,
Monomer (a2): a monomer having a crosslinkable group,
Monomer (a3): a vinyl ester having no crosslinkable group,
Compound (B): at least one compound selected from a potassium salt, a sodium salt, a magnesium salt and a hindered amine-type light stabilizer.

2. The process for producing a fluoroolefin copolymer powder for powder coating material according to claim 1, wherein the monomer (a2) is a vinyl ether having a crosslinkable group.

3. The process for producing a fluoroolefin copolymer powder for powder coating material according to claim 1, wherein the crosslinkable group in the monomer (a2) is a hydroxy group.

4. The process for producing a fluoroolefin copolymer powder for powder coating material according to claim 1, wherein the proportion of the monomer (a1) in the monomer mixture is from 20 to 80 mol % to the total of all monomers constituting the monomer mixture.

5. The process for producing a fluoroolefin copolymer powder for powder coating material according to claim 1, wherein the proportion of the monomer (a2) in the monomer mixture is from 0.5 to 30 mol % to the total of all monomers constituting the monomer mixture.

6. The process for producing a fluoroolefin copolymer powder for powder coating material according to claim 1, wherein the proportion of the monomer (a3) in the monomer mixture is from 0.5 to 30 mol % to the total of all monomers constituting the monomer mixture.

7. The process for producing a fluoroolefin copolymer powder for powder coating material according to claim 1, wherein the monomer mixture further contains at least one member selected from the group consisting of the following monomer (a4-1) and the following monomer (a4-2),
Monomer (a4-1): cyclohexyl vinyl ether,
Monomer (a4-2): a vinyl ether having a branched alkyl group and no crosslinkable group.

8. A composition for powder coating material comprising a fluoroolefin copolymer powder obtained by the process for producing a fluoroolefin copolymer powder as defined in claim 1 and a blocked isocyanate-type curing agent.

9. The composition for powder coating material according to claim 8, which further contains a non-fluororesin in an amount of from 10 to 400 parts by mass to 100 parts by mass of the fluoroolefin copolymer powder.

10. The composition for powder coating material according to claim 9, wherein the non-fluororesin is a polyester resin.

11. A powder coating material comprising the composition for powder coating material as defined in claim 8.

12. A coated article having a coating film formed from the powder coating material as defined in claim 11, on the surface of a substrate.

13. The coated article according to claim 12, wherein the substrate is made of aluminum.
